(19) United States
(12) Patent Application Publication
(10) Pub. No.: US 2005/0064222 A1
(43) Pub. Date: Mar. 24, 2005

(54) Component and method for manufacturing printed circuit boards

(76) Inventor: Miles Justin Russell, Hampstead, NH (US)

Correspondence Address: KEVIN FARRELL;PIERCE ATWOOD, ONE NEW HAMPSHIRE AVENUE, PORTSMOUTH, NH, 03801, US

(21) Appl. No.: 10/666,588

(22) Filed: Sep. 18, 2003

(51) Int. Cl. B32B 1/00; B32B 1/04; B32B 7/14; B32B 31/20; B32B 31/04

(52) U.S. Cl. 428/614; 428/77; 156/182; 156/247; 156/288; 156/291; 156/323; 156/289

(57) ABSTRACT

A laminated component includes a conductive film layer and a non-functional film layer joined to a first surface of the conductive film layer. One of the two film layers has larger lateral dimensions than the other film layer such that a portion of the larger film layer extends beyond the other film layer. In one embodiment, the two film layers are joined together by a band of adhesive defining a sealed central area inwardly thereof, and the portion of larger film layer extends beyond the other film layer on all sides thereof.

### BACKGROUND OF THE INVENTION

This invention relates generally to printed circuit boards and more particularly to methods and components used for manufacturing printed circuit boards.

Printed circuit boards generally comprise a substrate of a dielectric material having electrically conductive pathways formed thereon. The substrate supports a variety of electronic components connected by the conductive pathways. Printed circuit boards are typically constructed from an epoxy resin-impregnated glass fiber sheet, commonly known as “prepreg,” having a conductive film layer laminated on both sides. The conductive film layers are typically copper foil, although other electrically conductive materials, such as gold or silver foil, can be used. The copper foil is then etched to produce the desired conductive pathways. Multi-level printed circuit boards, also known as interconnect devices, comprise a number of stacked prepreg layers having a conductive “inner layer” interspersed between each pair of adjacent prepreg layers. Each inner layer has circuitry formed on both sides thereof so as to contain two levels of circuitry. An outer layer (typically copper foil) is laminated to the outer surface of each of the outermost two prepreg layers. As with single level printed circuit boards, the outer layers are subsequently etched to produce the desired circuitry.

Printed circuit board manufacturing, particularly of a dense, multi-level printed circuit boards, has undergone a steady evolution over approximately the past fifteen years. The production of the outer layers, which represents some of the final stages in the manufacturing process, is critical to the manufacturer because of the investment of time and materials that has gone into the device up to that point. In other words, substantial resources are expended in producing and assembling the prepreg and inner layers into a laminate (referred to herein as the “core assembly”) that comprises the middle of the multi-level device prior to the manufacture of the outer layers. If either outer layer is manufactured incorrectly, the entire device may need to be scrapped. In the case of a dense, complex device, the lost investment can be substantial.

Manufacture of printed circuit boards typically involves assembling the materials for a plurality of printed circuit boards into a stack, referred to as a book, for collective processing. Early manufacturing methods utilize steel plates (usually around 0.062 inches (1.57 millimeters) thick) in combination with single sheets of conductive film outer layers and core assemblies. These materials are laid up in the order of a steel plate, a conductive film layer, a core assembly, another conductive film layer, and another steel plate. This sequence is repeated for each printed circuit board in the book. The entire book is heated and subjected to pressure to bond the conductive outer layers to the core assembly and cure the prepreg. After cooling, the individual boards are separated from each other and subjected to final processing. This method is known as “conventional lamination.”

However, conventional lamination results in relatively high scrap rates. The scrap is due mainly to debris, such as resin dust or metal shavings, contaminating the conductive film that made up the outer layers. The source of this debris is often the environment where assembly took place or from the materials themselves. This debris causes damage to the conductive film outer layer during the lamination cycle. When the conductive film layer is imaged for the circuitry of the outer layer, the damaged areas where conductive pathways or other features landed often result in an open or short in the testing phase of the device and the device will need to be scrapped.

Another key contributor to damage on the copper surface of the outer layer is the kinks, folds and wrinkles that occur from the operator handling the thin conductive film during lay-up of the stack.

In the early 1990's, a category of products called “lamination foil” was developed to address the shortcomings of conventional lamination. Lamination foil is a laminate comprising a layer of electro-deposited conductive film that can be made of copper, gold, silver or some other conductive material, a stiff layer of alloy called the separator (most typically aluminum between 0.010 and 0.020 inches (254 and 506 microns) thick), and a second layer of conductive film. The surfaces of the separator and the adjacent conductive film surfaces are made to be clean and contaminate-free. In most versions of lamination foil, these clean surfaces are then sealed along all four borders by adhesives or mechanical welds. To assemble a book, a lamination foil is placed between each pair of core assemblies. The book is then subjected to heat and pressure to bond the conductive film layers to the adjacent core assembly. The conductive film layers thus become an outer layer of a printed circuit board. The separator is discarded after the lamination process.

By sealing the conductive film surface that is destined to become the outer layer of a printed circuit board, the debris that often caused defects in the conventional lamination method cannot enter the sealed package. Accordingly, the scrap rate relative to conventional lamination is dramatically reduced. In addition, the lamination foil separator acts to “stiffen” or provide structural support to the thin conductive film layers. This substantially reduces the damage that can occur while handling the discrete conductive film layers during lay-up in the conventional lamination technique.

The lamination foil separator also allowed manufacturers to largely discontinue the use of the steel plates used to assemble lamination books in the conventional lamination method. There are several benefits to not using steel plates. First, steel is a heat barrier. A lamination book built with steel plates between each device assembly takes more time and energy in the press to get to temperature. Second, the steel plates need ongoing maintenance to keep the surface defect free. Finally, the steel plates slow the assembly process prior to lamination and the disassembly process after lamination because of their weight.

Over the years the trend towards the miniaturization of electronics significantly increased the density or layer count of multi-level printed circuit boards. Manufacturers using lamination foil began to experience a phenomenon called “image transfer” in which the image of the circuitry from an underlying inner layer would get impressed into the copper layer that made up the outer layer despite the presence of the aluminum separator. The result of this “gravestone rubbing” effect was an outer layer with a rough topography that made subsequent processing much more difficult and resulted in much lower yields. Although harder aluminum separators were developed to reduce image transfer, the trend towards denser and denser circuitry devices did not stop. In certain situations, even the hardest aluminum available was unable to control image transfer and produce a smooth outer layer. To solve this problem, many manufacturers eventually came to the realization that the only way to avoid image transfer in some applications was to reintroduce the use of steel plates between each assembly in the lamination book. However, lamination foil continues to be used because it prevents contamination of the conductive film surfaces and facilitates handling of the extremely thin conductive films.

So, in effect, the industry has moved back to a methodology that is almost identical to the conventional lamination techniques used before the introduction of lamination foil, but with the added expense of lamination foil. In this case, the separator does not provide any image transfer resistance because that function is achieved by the steel plates. In other words, the most expensive part of the lamination foil, the separator, is essentially redundant in applications where steel plates are used between each assembly.

Accordingly, it would be desirable to provide a reliable, cost-effective means for laminating outer layers in the manufacture of printed circuit boards.

### SUMMARY OF THE INVENTION

The above-mentioned need is met by the present invention, which provides a laminated component including a conductive film layer and a non-functional film layer joined to a first surface of the conductive film layer. One of the two film layers has larger lateral dimensions than the other film layer such that a portion of the larger film layer extends beyond the other film layer. In one embodiment, the two film layers are joined together by a band of adhesive defining a sealed central area inwardly thereof, and the portion of larger film layer extends beyond the other film layer on all sides thereof.

The present invention and its advantages over the prior art will be more readily understood upon reading the following detailed description and the appended claims with reference to the accompanying drawings.

### DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawing figures in which:

FIG. 1 is a top view of a laminated component useful in manufacturing articles such as printed circuit boards, with the laminated component having a non-functional film layer shown in partial cut-away.

FIG. 2 is a side view of the laminated component of FIG. 1.

FIG. 3 is an exploded perspective view of the laminated component of FIG. 1.

FIG. 4 is an exploded side view of a lamination book including a plurality of the laminated components of FIG. 1.

### DETAILED DESCRIPTION OF THE INVENTION

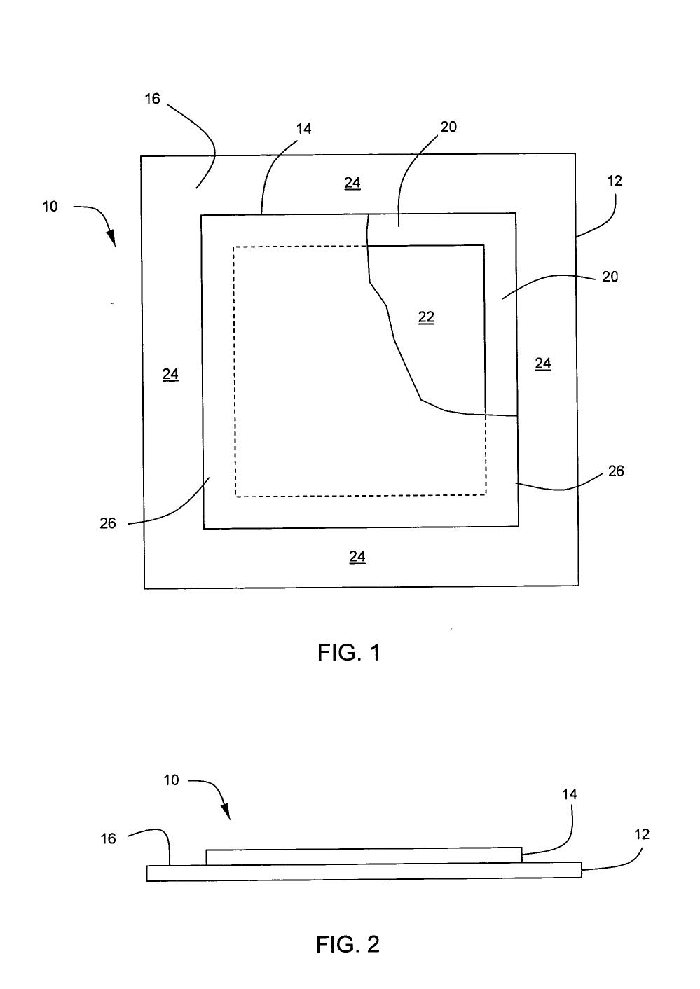

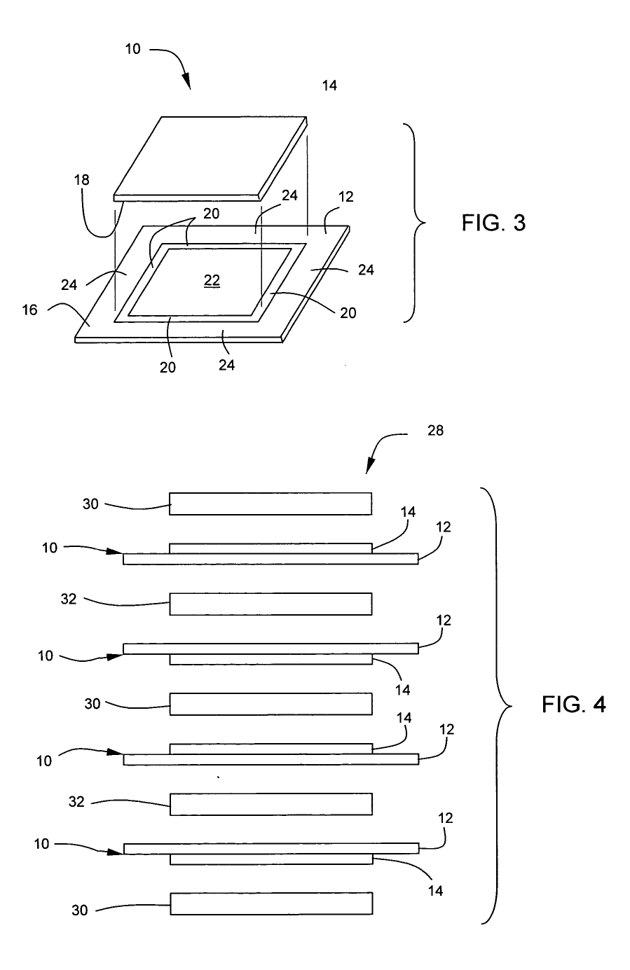

Referring to the drawings wherein identical reference numerals denote the same elements throughout the various views, FIGS. 1-3 show a laminated component 10 useful in manufacturing articles such as printed circuit boards. The component 10 comprises a conductive film layer 12 and a non-functional film layer 14. The conductive film layer 12 and the non-functional film layer 14 are joined together so that a first or inner surface 16 of the conductive film layer 12 is disposed flat against a first or inner surface 18 of the non-functional film layer 14. In the illustrated embodiment, the lateral dimensions of the conductive film layer 12 are larger than that of the non-functional film layer 14 so that a portion of the conductive film layer 12 extends beyond the non-functional film layer 14. Alternatively, the non-functional film layer 14 could have larger lateral dimensions than the conductive film layer 12 such that a portion of the non-functional film layer 14 extends beyond the conductive film layer 12. In other words, one of the two film layers should have larger lateral dimensions than the other film layer. The component 10 is preferably assembled under strict class 100 clean room conditions.

The conductive film layer 12 is a thin sheet of an electrically conductive material such as copper, gold, silver or the like and can be any thickness, although a thickness in the range of about 5-70 microns is typical. The non-functional film layer 14 is a thin sheet of any suitable material. Such suitable materials include, but are not limited to, aluminum, polytetrafluoroethylene (PTFE), or silicone. For example, the non-functional film layer can comprise a heat-treated aluminum foil. The non-functional film layer 14 can also be made of a paper- or cotton-based pad such as the PACOPADS press pads commercially available from Pacothane Technologies of New York, N.Y. The non-functional film layer 14 can be any thickness, but a thickness in the range of about 0.0005-0.003 inches (12.7-76.2 microns) is typical.

Adhesive 20 is applied on the first surface 16 of the conductive film layer 12. The adhesive 20 is applied in strips substantially parallel to each of the four outer edges of the conductive film layer 12 so as to create a rectangular, closed band that defines an enclosed central area 22 inwardly thereof on the inner surface 16. As will be described below, the central area 22 will become the functional outer layer of a multi-level printed circuit board. Accordingly, the lateral dimensions of the central area 22 should match the intended lateral dimensions of the printed circuit board. The non-functioning film layer 14 is ultimately discarded and does not become a functioning portion of the printed circuit board.

In the illustrated embodiment, the strips of adhesive 20 are applied a predetermined distance inward from the corresponding outer edges of the conductive film layer 12 so as to define a flashing area 24 along the outer edges of the conductive film layer 12, outside of the adhesive 20. With this arrangement, the central area 22 is centered on the conductive film layer first surface 16 and is framed or surrounded on all sides by the flashing area 24. As will be described below, the flashing area 24 will catch flowing resin during the lamination process. The predetermined distance between the strips of adhesive 20 and the outer edges is preferably in the range of about 0.5-2.0 inches (1.27-5.05 centimeters) depending on the amount of flashing area that will be needed to catch flowing resin. The strips of adhesive 20 are about 0.5 inches (1.27 centimeters) wide.

Through a precision process, the non-functional film layer 14 is placed over the band of adhesive 20. The non-functional film layer 14 preferably has lateral dimensions that are substantially equal to those of the band of adhesive 20. Because the lateral dimensions of the conductive film layer 12 are larger than that of the non-functional film layer 14, a portion of the conductive film layer 12 (namely, the flashing area 24) extends beyond the non-functional film layer 14 on all sides thereof. The conductive film layer 12 and the non-functional film layer 14 are pressed together over the strips of adhesive 20 to form a joint 26. The adhesive 20 joins the inner surface 16 of the conductive film layer 12 to the inner surface 18 of the non-functional film layer 14 along the entire periphery of the non-functional film layer 14. The joint 26 seals the interior of the component 10 from the external environment. As mentioned above, the component 10 is preferably assembled under strict class 100 clean room conditions so that the inner surfaces of the component 10 are as clean as possible. The seal joint 26 assures that the inner surfaces, particularly the central area 22 on the conductive film layer inner surface 16 (which will become the functional outer layer of a printed circuit board), will not be contaminated during subsequent lay-up and lamination processes. Tooling holes (not shown) are added to the component 10 per specification.

While the adhesive 20 has been described above as being first applied to the conductive film layer 12, it could alternatively be applied to the non-functional film layer 14 or to both film layers 12 and 14. The joint 26 can be made by means other than adhesive. Alternatives for joining the conductive film layer 12 and the non-functional film layer 14 include welding, soldering and mechanical means such as punching or stamping.

Referring to FIG. 4, a method for manufacturing multi-level printed circuit boards using the laminated component 10 is described. The various elements used in making the printed circuit boards are assembled into a lamination book 28. From bottom to top, the book 28 includes a first steel plate 30, a first laminated component 10, a core assembly 32, a second laminated component 10, and a second steel plate 30. As is known in the art, the core assembly 32 is a laminate comprising a stack of alternating prepreg layers and conductive inner layers with each inner layer having circuitry formed on both sides thereof. Each laminated component 10 is arranged so that its conductive film layer 12 abuts the adjacent core assembly 32 and its non-functional film layer 14 abuts the adjacent steel plate 30. This sequence is repeated for each printed circuit board to be part of the book 28. While FIG. 4 shows a book assembly with two printed circuit boards, the present invention is not limited to this number.

The entire book 28 is then heated and subjected to pressure to cure the prepreg resin of the core assemblies 32 and bond the conductive film layers 12 to the corresponding core assemblies 32. During this step, flowing resin from the core assemblies 32 flows onto, and is caught by, the extending flashing areas 24 of the conductive film layers 12. After cooling, the steel plates 30 are removed from the book 28 leaving two board assemblies. The non-functional film layers 14 are separated from the bonded conductive film layers 12 and discarded. The flashing areas 24 of the conductive film layers 12 are trimmed off. The bonded central areas 22 of the conductive film layers 12 remain as the functional outer layers of the resulting printed circuit boards.

Use of the laminated component 10 ensures that the surface that will become the functional outer layer of the printed circuit board is free from debris during the lamination process. By eliminating a separator and using a film layer just large enough to seal the central area 22, the laminated component uses a minimum of materials. The present invention thus provides a reliable, cost-effective way to laminate defect free printed circuit board outer layers for those fabricators using steel plates between each assembly.

While specific embodiments of the present invention have been described, it will be apparent to those skilled in the art that various modifications thereto can be made without departing from the spirit and scope of the invention as defined in the appended claims.

1. A laminated component for use in manufacturing articles such as printed circuit boards, said component comprising:
a conductive film layer; and
a non-functional film layer joined to a first surface of said conductive film layer, wherein one of said conductive film layer and said non-functional film layer has larger lateral dimensions than the other of said conductive film layer and said non-functional film layer such that a portion of said one film layer extends beyond said other film layer.

2. The component of claim 1 wherein said conductive film layer and said non-functional film layer are joined together by adhesive.

3. The component of claim 1 wherein said conductive film layer and said non-functional film layer are joined together by a band of adhesive defining a sealed central area inwardly thereof.

4. The component of claim 1 wherein said portion of said one film layer extends beyond said other film layer on all sides thereof.

5. The component of claim 1 wherein said one film layer and said other film layer are joined together at the periphery of said other film layer.

6. The component of claim 1 wherein said conductive film layer is made of copper.

7. The component of claim 1 wherein said non-functional film layer is made of a material selected from the group consisting of aluminum, polytetrafluoroethylene, silicone, paper-based material, and cotton-based material.

8. A laminated component for use in manufacturing articles such as printed circuit boards, said component comprising:
a first film layer;
a second film layer disposed against said first film layer, said second film layer having larger lateral dimensions than said first film layer such that a portion of said second film layer extends beyond said first film layer, wherein one of said first and second film layers is made of an electrically conductive material; and
a band of adhesive joining said first and second film layers and defining a sealed central area inwardly thereof.

9. The component of claim 8 wherein said second film layer extends beyond said first film layer on all sides thereof.

10. The component of claim 8 wherein said first film layer and said second film layer are joined together at the periphery of said first film layer.

11. The component of claim 8 wherein said first film layer and said band of adhesive define lateral dimensions that are substantially equal.

12. The component of claim 8 wherein said electrically conductive material is copper.

13. The component of claim 8 wherein another one of said first and second film layers is made of a material selected from the group consisting of aluminum, polytetrafluoroethylene, silicone, paper-based material, and cotton-based material.

14. A method of making printed circuit boards, said method comprising:
providing laminated components, each laminated component comprising a conductive film layer and a non-functional film layer joined to a first surface of said conductive film layer, wherein one of said conductive film layer and said non-functional film layer has larger lateral dimensions than the other of said conductive film layer and said non-functional film layer such that a portion of said one film layer extends beyond said other film layer;
assembling a book including a first steel plate, a first laminated component placed on said first steel plate, a core assembly placed on said first laminated component, a second laminated component placed on said core assembly, and a second steel plate placed on said second laminated component, wherein each laminated component is arranged so that its conductive film layer abuts said core assembly and its non-functional film layer abuts a corresponding one of said steel plates; and
subjecting said book to heat and pressure.

15. The method of claim 14 further comprising separating said non-functional film layers from said conductive film layers after subjecting said book to heat and pressure.

16. A method of making printed circuit boards, said method comprising:
providing laminated components, each laminated component comprising a first film layer, a second film layer disposed against said first film layer, and a band of adhesive joining said first and second film layers and defining a sealed central area inwardly thereof, said second film layer having larger lateral dimensions than said first film layer such that a portion of said second film layer extends beyond said first film layer, wherein one of said first and second film layers is made of an electrically conductive material;
assembling a book including a first steel plate, a first laminated component placed on said first steel plate, a core assembly placed on said first laminated component, a second laminated component placed on said core assembly, and a second steel plate placed on said second laminated component, wherein each laminated component is arranged so that its one film layer made of an electrically conductive material abuts said core assembly; and
subjecting said book to heat and pressure.

17. The method of claim 16 further comprising separating said first and second film layers after subjecting said book to heat and pressure.
